(19) United States
(12) Patent Application Publication
(10) Pub. No.: US 2018/0361316 A1
(43) Pub. Date: Dec. 20, 2018

(54) POWDERED COMPOSTION COMPRISING ONE OR MORE DOUBLE SALT(S) FOR USE IN COMBUSTION GAS PURIFICATION

(71) Applicants: Bernard Somerhausen, Nivelles (BE); Nicolas Vekony, Chastre (BE)

(72) Inventors: Bernard Somerhausen, Nivelles (BE); Nicolas Vekony, Chastre (BE)

(73) Assignee: CARMEUSE RESEARCH AND TECHNOLOGY, Louvain-la-neuve (BE)

(21) Appl. No.: 15/781,917

(22) PCT Filed: Dec. 8, 2016
(86) PCT No.: PCT/EP2016/080217

§ 371 Date: Jun. 6, 2018

(30) Foreign Application Priority Data
Dec. 14, 2015 (EP) 15199901.8

(51) Int. Cl. B01D 53/82; B01D 53/50; B01D 53/56; B01D 53/68

(52) U.S. Cl. CPC B01D 53/82; B01D 2257/302; B01D 53/565; B01D 53/685; B01D 2251/302; B01D 2251/304; B01D 2251/306; B01D 2251/402; B01D 2251/404; B01D 2251/604; B01D 2251/606; B01D 2257/2045; B01D 2257/2047; B01D 2257/404; B01D 53/508

(57) ABSTRACT

The present invention is related to a method for the removal of noxious components from a gas stream wherein an absorbent composition comprising one or more double salts is contacted with said gas stream at a temperature comprised between 100 and 400° C.

### FIELD OF THE INVENTION

The present invention is related to a powdered composition comprising one or more double salt(s) and the use of said composition for the removal of acid gases from a combustion gas stream.

The use of alkali metal compounds and/or alkaline earth compounds for purification of combustion gases is known by those skilled in the art and has been subject of a considerable number of patents.

U.S. Pat. No. 4,233,175 discloses a reagent for treating flue gases. The reagent is an intimate mixture of a powdered main component such as calcium and magnesium oxides, hydroxides, carbonates, bicarbonates, and mixtures thereof, and an additive such as chloride and bromide salts of alkali metals, ammonium, alkaline earth metals, and mixtures thereof in an amount of from 0.1 to 15% by mole with respect to said powdered main component.

U.S. Pat. No. 4,533,532 discloses a method of removing sulfur dioxide and other toxic components from the flue gas of a power plant boiler. The absorbent is an intimate mixture of at least one alkaline earth compound with 0.1 to 10% by mole of at least one carboxylic acid or an alkali metal, alkaline earth metal or ammonium salt thereof.

U.S. Pat. No. 4,588,568 discloses a method of binding sulfur compounds produced during the combustion of sulfur-containing fuels wherein an additive consisting of sodium carbonate and a magnesium oxide is added into the periphery of the respective flames.

U.S. Pat. No. 4,795,619 discloses a method for the removal of acid gases from a flue gas comprising dispersing an alkaline reactant, selected from at least one of a group consisting of the alkali metal and alkaline earth metal oxides, hydroxides, carbonates and bicarbonates, and a deliquescent compound, selected from the group consisting of sodium carbonate, sodium bicarbonate, sodium chloride, calcium sulphate, magnesium sulphate, magnesium carbonate, and sodium sulphate, in the air stream.

U.S. Pat. No. 4,859,438 discloses a method of separating SO₂ and NOₓ wherein x is 1 or 2 from flue gas at a temperature below 400° C. The absorbent includes NaHCO₃ and at least one of Al(OH)₃, Al₂O₃, Ca(OH)₂, CaCl₂, and NH₄HCO_{3.}

U.S. Pat. No. 5,096,680 discloses a method for purifying waste gas including of SOₓ, HCl, HF, NOₓ, CO and CₙHₘ as impurities utilizing a sorbent comprising a hydrogen carbonate selected from KHCO₃, NH₄HCO₃, NaHCO₃, and Mg(HCO₃)₂ and a hydroxide selected from calcium hydroxide or magnesium hydroxide.

U.S. Pat. No. 7,744,678 discloses a powdered lime composition having an alkali metal content comprised between 0.2 and 3.5% by weight based on the total weight of the composition. The alkali metal compound is selected from the group consisting of alkali metal hydroxides, carbonates, hydrogencarbonates, nitrates, phosphates, persulphates and monocarboxylates, and mixtures thereof.

US 2012/0235086 discloses a mineral desulfurizing agent, comprising calcium-based porous granules which comprise a core containing at least 80% by weight of CaCO₃ and at least one agglomeration layer enclosing the core and containing Ca(OH)₂ and up to 30% by weight, relative to the total dry weight of the granules, of at least one other desulfurizing agent selected from Mg(OH)₂, CaO, CaCO₃ and NaHCO_{3.}

WO 88/09203 discloses a process for producing calcium hydroxides which are particularly suited for the purification of gases and exhaust gases. For this purpose, substances are added to the slaking water for dead-burnt lime which enhance the reactivity of Ca(OH)₂. These substances are alkalis such as NaHCO₃ or hydrate-forming substances such as CaCl₂ or hydroxide-forming substances such as FeCl_{3.}

WO 89/11329 discloses a means for the purification of gases and exhaust gases comprising a dry powder based on reactive Ca(OH)₂ comprising from 0.05 to 50% by weight of products such as activated charcoal, brown coal open-hearth coke, activated alumina and silica gel. The Ca(OH)₂ obtained is particularly suitable for removing Hg from gases and exhaust gases.

WO 2007/031552 discloses a method of removing SO₃ from a flue gas stream wherein a sorbent composition is injected into the flue gas stream. The sorbent composition, such as mechanically refined trona (trisodium hydrogendicarbonate dihydrate Na₃(CO₃)(HCO₃).2H₂O) or sodium bicarbonate, includes 0.1 to 5% by weight of an additive, selected from the group consisting of magnesium carbonate, calcium carbonate, magnesium hydroxide, calcium hydroxide, and mixtures thereof, and a sodium sorbent.

DE 2822086 discloses a method for the production of a powdered dry absorbent by the hydration of an alkaline earth oxide in the presence of an alkaline earth halide, added to the alkaline earth oxide prior to hydration or added to the hydration water.

US 2009/0220411 discloses a method of forming an activated lime for the removal of acid gases from a combustion gas stream comprising thermally decomposing Ca(OH)₂ to produce CaO having a specific surface area of between about 30-48 m²/g.

US 2015/0157977 discloses a method for increasing the absorbency of a material containing alkaline earth metal carbonate and alkaline earth metal hydroxide in relation to sulphur oxides and/or other pollutants in flue gas, wherein said material is activated by heating to a temperature comprised between 250 and 750° C. for a duration of from 1 minute to 12 hours.

JP2006181451 discloses a method of reducing dioxins in fly ash generated by refuse incineration equipment by bringing porous Na₂CO₃ and Ca(OH)₂ into contact with the fly ash in the flue at temperatures comprised between 100 and 300° C.

IT 0001401506 discloses an absorbing powder composition to purify a gaseous effluent comprising Ca(OH)₂ and from 10.0 to 60.0% by weight, with respect to the overall weight of the composition, of a salt of the HCO₃-ion. The adsorbing composition is prepared in a process comprising dry grinding a blend comprising Ca(OH)₂ and a HCO₃-salt.

WO 2015/085375 discloses a composition for treating flue gasses comprising more than 80% by weight of Ca(OH)₂, an additive selected from the group consisting of NaCl, Na₂SO₄, CaCl₂ and at least 1% by weight of a sodium comprising component selected from the group consisting of NaOH, Na₂CO₃, NaHCO₃ and at most 5% by weight of water.

Absorbent compositions based on calcium are known to be efficient removers of acid gases from a combustion gas stream in a temperature range comprised between room temperature and 170° C., a temperature range comprised between 400 and 600° C. and a temperature range comprised between 1100 and 1400° C.

On the other hand, absorbent compositions based on alkali metal salts are known to be inefficient acid gas removers below 135° C., while being efficient within limited ranges between 160 and 400° C. Sodium bicarbonate, for example, is an efficient remover of acid gasses within limited ranges of a temperature range comprised between 160 and 400° C.

Absorbent compositions based on alkali metal salts, more particularly based on sodium salts, are expensive compared to those based on alkaline earth metal salts, more particularly based on calcium salts. Moreover leaching of exhausted absorbent based on alkali metal salts is considerably higher than leaching of exhausted absorbent based on alkaline earth metal salts.

### AIMS OF THE INVENTION

The present invention aims to provide an absorbent composition for the removal of acid gases from a combustion gas stream that does not present the drawbacks of the state of the art.

The present invention aims to provide an economical attractive absorbent composition proving an optimal acid gas removal efficiency from a combustion gas stream within a temperature range comprised between 100 and 400° C., said optimal efficiency being present within the entire temperature range, whereby the exhausted absorbent composition is characterized by leaching properties comparable to those of the exhausted absorbent compositions based on alkaline earth metal salts.

### SUMMARY OF THE INVENTION

The present invention discloses a method for the removal of noxious components from a gas stream comprising the steps of:
contacting a powdered composition with the gas stream, said composition comprising a mix of:
   one or more double salts having the general formula selected from the group consisting of:

A₂BY₂;ABX₃;A₃XY and B₂X₂Y; and
one or more component(s) having the general formula selected from the group consisting of:

AX;A₂Y;BX₂;BY and BZ₂;
wherein
   A is a cation selected from the group consisting of lithium, sodium and potassium;
   B is a cation selected from the group consisting of calcium and magnesium;
   X is a bicarbonate anion;
   Y is a carbonate cation; and
   Z is an hydroxyl group;
separating the exhausted powdered composition from the treated gas stream.

Preferred embodiments of the invention disclose one or more of the following features:
the powdered composition comprises:
   from 5 to 95% by weight, preferably from 10 to 90% by weight, more preferably from 15 to 85% by weight of one or more double salts having the general formula selected from the group consisting of:

A₂BY₂;ABX₃;A₃XY and B₂X₂Y and
from 95 to 5% by weight, preferably from 90 to 10% by weight, more preferably from 85 to 15% by weight of one or more component(s) having the general formula selected from the group consisting of:

AX;A₂Y;BX₂;BY and BZ₂;

wherein the total amount of double salt(s) and component(s) in the double salt/component mix represents 100% by weight;
each of the one or more double salt(s), is characterized by a substantially single crystal system;
the one or more double salts are obtained from reacting at least one salt comprising an alkali metal or an alkaline earth metal cation and at least one base comprising an alkaline earth metal cation, said at least one base being obtained from the hydration of the corresponding alkaline earth metal oxide;
the powdered composition comprises pirssonite of the formula Na2Ca(CO3)2.2H2O and/or gaylussite of the formula Na2Ca(CO3)2.5H2O;
the noxious components comprise SO2, SO3, NO, NO2, HCl and HF;
the gas stream is contacted with the powdered composition at a temperature comprised between 100 and 400° C., preferably between 150 and 400° C., more preferably between 170 and 400° C.;
the powdered composition is thermally activated at a temperature between 100° C. and 400° C. for a duration of from 1 to 40 seconds, preferably of from 1 to 30 seconds, more preferably of from 1 to 20 seconds, most preferably of from 1 to 10 seconds;
the powdered composition is thermally activated in the gas stream to be purified;
the thermally activated powdered composition is characterized by a BET, specific surface area, according to ASTM D-3037-93 of at least 2 m2/g, preferably at least 4 m2/g, more preferably at least 5 m2/g;
the powdered composition is injected in the gas stream or in a combustion chamber;
the powdered composition is applied to one or more plate(s), sieve(s), grid(s) or sorption bed(s), situated in the discharge channel of the gases to be purified;
the gas to be purified is a combustion gas.

### DETAILED DESCRIPTION OF THE INVENTION

The present invention provides a powdered absorbent comprising one or more double salt(s), said double salts being characterized by an optimal acid gas removal efficiency from a combustion gas stream when contacted with said gas stream at a temperature comprised between 100 and 400° C., said optimal acid gas removal efficiency being effective over the whole temperature range.

By acid gases, the present invention means sulfur dioxide (SO₂), sulfur trioxide (SO₃), nitrogen oxide (NO), nitrogen dioxide (NO₂), hydrogen chloride (HCl) and hydrogen fluoride (HF).

By optimal acid gas removal efficiency the present invention means a reduction of the acid gas content by at least 25%, preferably by at least 30%, more preferably by at least 45%, most preferably by at least 60% or even 75% of its initial value.

The double salt of the present invention is defined as a salt,

containing more than one cation and/or anion,
preferably being characterized by a single crystal system and
presenting different physicochemical properties than of its component single salts.

The double salt is considered as one pure substance and not as a mixture of two separate salts.

The double salts of the present invention comprise:

two cations and one anion, and/or
one cation and two anions, and/or
two cations and two anions,
wherein the cations are selected from the group consisting of the alkali-metal and the alkaline earth metals and wherein the anions are selected from the group consisting of bicarbonate and carbonate.

For the particular case where the double salt comprises two different cations, one of said cations is selected from the alkali metal group, preferably lithium, sodium and potassium, while the other cation is selected from the alkaline earth metal group, preferably calcium and magnesium.

The double salt of the present invention is preferably obtained from reacting two or more salts and/or from reacting one or more salt(s) and one or more base(s) and/or from reacting one or more salt(s) and one or more oxide(s), wherein the base and the oxide preferably comprise an alkaline earth cation.

The reaction may be performed in a dry or liquid state, preferably under the influence of heat. Preferably the reaction is performed in the liquid state, more preferably in aqueous medium.

Preferably a first salt and/or the base and/or the oxide comprising the alkaline earth metal is mixed to a stoichiometric excess of water whereupon a second salt, in solid form, is added while stirring at a temperature comprised between 20 and 100° C.

Within the context of the present invention the weight ratio of the one or more salt(s) comprising an alkali metal cation over the one or more salt(s) and/or base(s) and/or oxide(s) comprising an alkaline earth metal cation preferably is comprised between 90/10 and 10/90, more preferably between 85/15 and 15/85, most preferably between 80/20 and 20/80.

Preferably the reaction mixture comprising two or more salt(s) or the reaction mixture comprising one or more salt(s) and one or more base(s) or oxide(s), comprises at least 10% by weight, preferably at least 20% by weight, more preferably at least 30% by weight, most preferably at least 40% by weight or even at least 50% by weight of one or more salt(s) comprising the alkali metal cation, with respect to the total weight of salt(s) and/or base(s) and/or oxide(s).

The absorbent composition of the present invention comprises one or more double salt(s) and further may comprise one or more components selected from the group consisting of the initial salts (used as reagents for the synthesis of the double salt); the initial salts wherein the cation, or the anion, or the conjugated base of said anion has been exchanged; the base(s) and mixtures of them.

The absorbent composition of the present invention comprises from 5 to 95% by weight, preferably from 10 to 90% by weight, more preferably from 15 to 85% by weight, most preferably from 20 to 80% by weight or even from 25 to 75% by weight of one or more double salts.

The absorbent composition is characterized by a BET, specific surface area, according to ASTM D-3037-93 of at least 2 m²/ g, preferably at least 4 m²/ g, more preferably at least 5 m²/ g.

The absorbent composition preferably is characterized by a BET, specific surface area, according to ASTM D-3037-93 of 30 m²/ g or less, more preferably of 20 m²/g or less, most preferably of 15 m²/g or less or even 10 m²/g or less.

The double salts preferably are characterized by a substantially single crystal system (triclinic, monoclinic, orthorhombic, tetragonal, trigonal, hexagonal and cubic). By a substantially single crystal system, the present invention means that at least 95%, preferably for at least 99%, of a double salt of a specific formula is crystallized in said specific single crystal system.

The double salt of the present invention preferably is obtained from reacting hydrated lime and sodium carbonate or sodium bicarbonate, and preferably is characterized by a crystal system selected from the group consisting of the orthorhombic and the monoclinic crystal system.

The absorbent composition of the present invention preferably comprises at least one double salt selected from the group consisting of pirssonite of the formula Na₂Ca(CO₃)₂.2H₂O, gaylussite of the formula Na₂Ca(CO₃)₂.5H₂O and mixtures thereof, said at least double salt optionally further comprising trona of the formula Na₂CO₃.NaHCO₃.2H₂O.

The absorbent composition of the present invention further may comprise one or more components selected from the group consisting of Ca(OH)₂, CaCO₃, Na₂CO₃.NaHCO₃ and mixtures of them.

The absorbent composition of the present invention comprises from 10 to 90% by weight, preferably from 15 to 85% by weight, more preferably from 20 to 80% by weight and most preferably from 25 to 75% by weight of one or more double salts selected from the group consisting of pirssonite of the formula Na₂Ca(CO₃)₂.2H₂O, gaylussite of the formula Na₂Ca(CO₃)₂.5H₂O and mixtures thereof and optionally trona of the formula Na₂CO₃.NaHCO₃.2H₂O.

The absorbent composition of the present invention further may comprise from 90 to 10% by weight, preferably from 85 to 15% by weight, more preferably from 80 to 20% by weight and most preferably from 75 to 25% by weight of one or more components selected from the group consisting of Ca(OH)₂, CaCO₃, Na₂CO₃, Na₂CO₃.xH₂O (0≤×≤10), NaHCO₃ and mixtures thereof.

In one embodiment, the method of the present invention comprises adding lime to a stoichiometric excess of water in such an amount that a mixture of hydrated lime in water comprising between 1 and 60% by weight, preferably between 1 and 40% by weight, more preferably between 1 and 30% by weight, most preferably between 5 and 20% by weight of water is obtained. The addition of lime to water is exothermic as a result of which the mixture heats up.

To the mixture of hydrated lime and water, standing at a temperature comprised between 20 and 100° C., preferably between 25 and 65° C., more preferably between 30 and 50° C., sodium bicarbonate and/or sodium carbonate, in solid form, is added, while stirring, in such a way that the temperature of the mixture remains substantially unmodified.

By a substantially unmodified temperature the present invention means a deviation of less than 20° C., preferably less than 10° C. from the set temperature.

In order to maintain the substantially unmodified temperature of the reaction mixture, the sodium bicarbonate and/or sodium carbonate feed rate can be monitored and/or heating means can be applied.

The reaction mixture is characterized by a weight ratio of sodium bicarbonate and/or sodium carbonate over calcium hydroxide comprised between 90/10 and 10/90, preferably between 85/15 and 15/85, more preferably between 80/20 and 20/80.

Preferably the reaction mixture comprising sodium bicarbonate and/or sodium carbonate and calcium hydroxide comprises at least 10% by weight, preferably at least 15% by weight, more preferably at least 20% by weight or even at least 25% by weight of sodium bicarbonate and/or sodium carbonate.

More preferably the reaction mixture comprising sodium bicarbonate and/or sodium carbonate and calcium hydroxide comprises at least 30% by weight, preferably at least 35% by weight, more preferably at least 40% by weight of sodium bicarbonate and/or sodium carbonate.

Preferably the reaction mixture comprising sodium bicarbonate and/or sodium carbonate and calcium hydroxide comprises 85% by weight or less, preferably 80% by weight or less , more preferably at least 75% by weight or less of sodium bicarbonate and/or sodium carbonate.

After completion of the sodium bicarbonate and/or sodium carbonate feeding the reaction mixture preferably is maintained at a temperature comprised between 20 and 100° C., preferably between 25 and 65° C., more preferably between 30 and 50° C. for a time period comprised between 1 and 100 minutes, preferably between 5 and 80 minutes, more preferably between 10 and 60 minutes, whereupon the reaction mixture is allowed to slowly cool down.

The reaction mixture is optionally kept at room temperature, optionally while stirring, for a time period of up to 48 hours, preferably up to 36 hours, more preferably up to 24 hours, whereupon the solid comprising one or more double salt(s) is optionally separated from the water.

The inventors have observed that absorbent composition(s) comprising one or more double salt(s) and 25% by weight or less, preferably 20% by weight or less, more preferably 15% by weight or less, most preferably 10% by weight or less of water is a free flowing powder.

The absorbent composition thus obtained comprises from 10 to 90% by weight, preferably from 15 to 85% by weight, more preferably from 20 to 80% by weight, most preferably from 25 to 75% by weight of one or more double salts selected from the group consisting of pirssonite of the formula Na₂Ca(CO₃)₂.2H₂O, gaylussite of the formula Na₂Ca(CO₃)₂.5H₂O and optionally trona of the formula Na₂CO₃.NaHCO₃.2H₂O.

The absorbent composition further comprises from 90 to 10% by weight, preferably from 85 to 15% by weight, more preferably from 80 to 20% by weight, most preferably 75 to 25% by weight of one or more components selected from the group consisting of sodium carbonate, sodium bicarbonate, calcium carbonate and calcium hydroxide.

In another embodiment the method of the present invention comprises dry blending hydrated lime and sodium bicarbonate while heating to a temperature comprised between 20 and 100° C., preferably between 25 and 65° C., more preferably between 30 and 50° C., for a time period comprised between 1 and 100 minutes, preferably between 5 and 80 minutes, more preferably between 10 and 60 minutes, whereupon the blend is allowed to cool down to room temperature, optionally while blending.

The method of the present invention further may comprise the additional step of thermally activating the absorbent composition. In order to perform thermal activation, the absorbent composition of the present invention is heated to a temperature above 50° C., preferably to a temperature comprised between 100 and 400° C. for a time period comprised between 1 and 40 seconds, preferably for a time period comprised between 1 and 30 seconds, more preferably for a time period comprised between 1 and 20 seconds, most preferably for a time period comprised between 1 and 10 seconds.

The absorbent composition of the present invention is used to remove acid gases from a combustion gas stream

Hereto the absorbent composition is injected either in the gas stream or in the combustion chamber or otherwise is applied to one or more plate(s), sieve(s), grid(s) or sorption bed(s), situated in the discharge channel of the combustion gases.

In general the weight ratio of “absorbent composition to acid gases” is at least 1.5, preferably at least 2, more preferably at least 2.5 and most preferably at least 3.

Preferably, the weight ratio of “absorbent composition to acid gases” is 8 or less, preferably 7.5 or less, more preferably 7 or less or even 6 or less.

In general the absorbent composition of the present invention is thermally activated during its use in the combustion gas stream.

Thermal activation results in a phase change in the X-ray diffraction experiment and in a mass loss as obtained from thermogravimetric analysis.

Without being bound by any particular theory, it is believed that the thermal activation of the absorbent composition increases its surface and porosity, favouring the absorption of the acid gases over a wide temperature zone, more specifically over a temperature zone comprised between 100 and 400° C.

The thermally activated absorbent composition of the present invention exhibits an optimal removal efficiency of acid gases from a combustion gas stream over a temperature zone comprised between 100 and 400° C.

Within the context of the present invention the combustion gas stream comprises 10,000 ppmv or less, preferably 5000 ppmv or less, more preferably 1000 ppmv or less, most preferably 800 ppmv or less of a total acid gases.

Within the context of the present invention the combustion gas stream comprises at least 50 ppmv, preferably at least 100 ppmv, more preferably at least 150 ppmv, most preferably at least 200 ppmv of a total acid gases.

The use of the absorbent composition of the present invention enables to obtain combustion air comprising 200 ppmv or less, preferably 150 ppmv or less, more preferably 100 ppmv or less, most preferably 50 ppmv or less or even 40 ppmv or less of a total acid gases, when applied to a combustion gas stream at a temperature comprised between 100 and 400° C.

### EXAMPLES

The following illustrative examples are merely meant to exemplify the present invention and are not destined to limit or otherwise define the scope of the present invention.

### Example 1

A gas stream, at a temperature of 160° C., comprising 350 ppmv of SO₂, 5% vol. of CO₂ and 11% vol. of water was passed through a bag filter with a filter area of 35 m² consisting of 12 rows, each row comprising 5 filter bags with a length of 1 m and a side surface of 0.58 m² and with air to cloth ratio of 1 m/min.

At the same time, the powdered absorbent composition of examples 2 and 3, respectively and comparative examples 1 and 2, was introduced in a continuous manner at a constant flow rate into the bag filter at a specific weight ratio of “absorbent composition to SO₂”.

The gas stream flowed from outside to inside the bag. Each row of 12 bags was each individually cleaned by a short burst of compressed air, injected through a common manifold, with a time interval comprised between 30 and 60 minutes. This compressed air burst while travelling through the entire length of the bag caused the bag surface to flex, breaking the dust cake comprising exhausted absorbent (sulfate salts) into powder which was isolated.

### Example 2

To the first chamber (premixing chamber) of an industrial lime hydrator, comprising three chambers, lime is fed at a rate of 4,000 kg/hr (feed size: 0 -10 mm) along with 3,500 1/hr of water. After the second chamber (main hydrating chamber) for controlled hydration of the lime, sodium carbonate was added to the third chamber at a rate of 780 kg/hr and reacted at a temperature 40° C.

The final absorbent composition, as obtained at the exit of the third chamber (reaction/maturing chamber), comprises 10% of water and is further composed of:
Ca(OH)₂: 72% by weight
Na₂Ca(CO₃)₂.2H₂O (pirssonite): 18%
Na₂CO₃.H₂O: 0.5%
amorphous part: 0.5%
as revealed by semi-quantitative X-ray diffraction.

### Example 3

Example 2 was repeated with the exception 4,000 kg of sodium bicarbonate was added to the third chamber instead of 780 kg of sodium carbonate. The absorbent composition was subjected to semi-quantitative X-ray diffraction which revealed the composition below:
Ca(OH)₂: 20% by weight
Na₂Ca(CO₃)₂.2H₂O (pirssonite): 59%
Na₂Ca(CO₃)₂.5H₂O (gaylussite): 10%
Na₂CO₃.H₂O: 0.5%
amorphous part: 0.5%

### Example 4

Example 1 was performed with the powdered absorbent composition of example 2.

The SO₂ capture efficiency a.f.o. the weight ratio of “absorbent composition of example 2 to SO₂” is given in the table below:

| weight ratio “absorbent composition | SO₂ capture |
|---|---|
| of example 2 to SO₂” | efficiency (%) |
| 2.2 | 28 |
| 3.5 | 38 |
| 4.0 | 40 |
| 4.5 | 43 |
| 5.0 | 45 |

Example 5

Example 1 was performed with the powdered absorbent composition of example 3.

The SO₂ capture efficiency for a weight ratio of “absorbent composition of example 3 to SO₂” of 4, is 55%.

### Example 6

Example 5 was repeated for a gas stream standing at 240° C. instead of 160° C. wherein the filter bags were adapted for resisting said temperature.

The SO₂ capture efficiency for a weight ratio of “absorbent composition of example 3 to SO₂” of 4.1, is 62%.

### Comparative Example 1

Example 1 was performed with a standard hydrated lime (BET=22 m²/g) as powdered absorbent composition.

The SO₂ capture efficiency for a weight ratio of “hydrated lime to SO₂” of 2.2, is 16%.

### Comparative Example 2

Example 1 then was performed with a salt blend comprising 85% by weight of hydrated lime and 15% by weight of sodium bicarbonate, said blend being obtained from intensively mixing at room temperature.

The SO₂ capture efficiency for a weight ratio of “salt blend to SO₂” of 4, is 26%.

### Comparative Example 3

Comparative example 1 was repeated for a gas stream standing at 240° C. instead of 160° C. wherein the filter bags were adapted for resisting said temperature.

The SO₂ capture efficiency for a weight ratio of “absorbent composition of comparative example 2 to SO₂” of 2.1, is 8%.

From above examples and comparative examples, it clearly appears that:
the absorbent composition of the present invention proves comparable SO₂ capture efficiencies at different temperatures (example 5 versus example 6);
the capture efficiency of the absorbent composition of the present invention is better than the capture efficiency of one of its composing components (Example 2/row 1 of table: 28% versus comparative example 1:16%);
the capture efficiency of the absorbent composition of the present invention is better than the capture efficiency of a blend of its composing salts (Example 2/row 3 of table: 40% versus comparative example 2:26%).

The exhausted absorbent of example 4 and 5 were characterized by a leaching comparable to the leaching of the exhausted absorbent of comparative example 1 which all are considerably lower than the leaching properties of comparative example 2.

1. A method for the removal of noxious components from a gas stream comprising the steps of:
contacting a powdered composition with the gas stream, said composition comprising a mix of:
one or more double salts having the general formula selected from the group consisting of:
A₂BY₂;ABX₃;A₂BX₂Y; and
one or more component(s) having the general formula selected from the group consisting of:
AX;A₂Y;BX₂;BY and BZ₂;
wherein
A is a cation selected from the group consisting of lithium, sodium and potassium;
B is a cation selected from the group consisting of calcium and magnesium;
X is a bicarbonate anion;
Y is a carbonate anion and
Z is an hydroxyl group;
separating the exhausted powdered composition from the treated gas stream.

2. The method according to claim 1 wherein the powdered composition comprises:
from 5 to 95% by weight, preferably from 10 to 90% by weight, more preferably from 15 to 85% by weight of one or more double salts having the general formula selected from the group consisting of:
A₂BY₂;ABX₃;A₂BX₂Y; and
from 95 to 5% by weight, preferably from 90 to 10% by weight, more preferably from 85 to 15% by weight of one or more component(s) having the general formula selected from the group consisting of:
AX;A₂Y;BX₂;BY and BZ₂;
wherein the total amount of double salt(s) and component(s) in the double salt/component mix represents 100% by weight.

3. The method according to claim 1 wherein each of the one or more double salt(s), is characterized by a substantially single crystal system.

4. The method according to claim 1 wherein the one or more double salts are obtained from reacting at least one salt comprising an alkali metal or an alkaline earth metal cation and at least one base comprising an alkaline earth metal cation, said at least one base being obtained from the hydration of the corresponding alkaline earth metal oxide.

5. The method according to claim 1, wherein the powdered composition comprises pirssonite of the formula Na₂Ca(CO₃)₂.2H₂O and/or gaylussite of the formula Na₂Ca(CO₃)₂.5H₂O.

6. The method according to claim 1, wherein the noxious components comprise SO₂, SO₃, NO, NO₂, HCl and HF.

7. The method according to claim 1, wherein the gas stream is contacted with the powdered composition at a temperature between 100 and 400° C.

8. The method according to claim 1, wherein the powdered composition is thermally activated at a temperature between 100° C. and 400° C. for a duration of from 1 to 40 seconds.

9. The method according to claim 1, wherein the powdered composition is thermally activated in the gas stream to be purified.

10. The method according to claim 9, wherein the thermally activated powdered composition is characterized by a BET, specific surface area, according to ASTM D-3037-93 of at least 2 m²/g₇ .

11. The method according to claim 1, wherein the powdered composition is injected in the gas stream or in a combustion chamber.

12. The method according to claim 1, wherein the powdered composition is applied to one or more plate(s), sieve(s), grid(s) or sorption bed(s), situated in the discharge channel of the gases to be purified.

13. The method according to claim 1, wherein the gas to be purified is a combustion gas.
